(19) United States
(12) Patent Application Publication
(10) Pub. No.: US 2009/0067197 A1
(43) Pub. Date: Mar. 12, 2009

(54) Decorative Lamp

(76) Inventor: Chi Liang SHAO, Dongguan City (CN)

Correspondence Address: TROXELL LAW OFFICE PLLC, SUITE 1404, 5205 LEESBURG PIKE, FALLS CHURCH, VA, 22041, US

(21) Appl. No.: 12/173,162

(22) Filed: Jul. 15, 2008

(30) Foreign Application Priority Data
Sep. 11, 2007 (CN) 200720194228.4

(51) Int. Cl. H01R 33/00

(52) U.S. Cl. 362/654

(57) ABSTRACT

The present invention relates to a lamp string, particularly to a decorative lamp. The decorative lamp includes a flowered shell, a soft core, and a soft head. The flowered shell is defined in the top of the soft core. The soft head is defined in the bottom of the soft core. The fitting place of the flowered shell and the soft core is integrally formed by injection molding. The present invention has the following advantages; the first is that the integrative structure of the fitting place of the flowered shell and the soft core can prevent the leakage of rain; the second is the extension of the service life and the reduction of the using cost; the third is the convenience of the replacement; the fourth is the reasonable idea, the novel design and the market potential.

### BACKGROUND OF THE INVENTION

1. Field of the Invention

The present invention relates to a lamp string, particularly to a decorative lamp.

2. Description of the Prior Art

A lamp string formed by a decorative lamp and other electrical parts is widely used in people's living, such as in festival and holiday. People often hang up the lamp string indoor and outdoor. The colorful ray of the lamp string can serve as a foil to the environment, which can have the function of propaganda when the lamp string is used in the billboard, and which can beautify the city's appearance when the lamp string is used in the city decoration. Thus, the decorative lamp is widely used and so beautifies people's living. The conventional decorative lamp is composed with a flowered shell, a soft core and a soft head. The flowered shell connects with the soft core by clipping or pressing, which fits to be used indoor. However, when the lamp string is used outdoor, water is ready to enter the flowered shell. For example, when it rains, water will be able to leak from the fitting place of the flowered shell and the soft core, which results in oxidating the parts, speeding up the aging, reducing the service life and increasing the use cost.

### SUMMARY OF THE INVENTION

To overcome the deficiency of the prior art, an object of the present invention is to provide a decorative lamp which can prevent the leakage of rain, extend the period of using, and make the structure simple, the cost low and the replacement convenient.

To achieve the above object, a decorative lamp includes: a flowered shell, a soft core, and a soft head. The flowered shell is defined in the top of the soft core. The soft head is defined in the bottom of the soft core. The fitting place between the opening of the flowered shell and the soft core is an integrative structure of injection molding.

The fitting place between the opening of the flowered shell and the soft core is integrally formed by fusion.

The fitting place between the opening of the flowered shell and the soft core is integrally formed by ultrasonic technique.

The luminophor disposed at the soft core is an LED lamp.

A block button is disposed at the soft core, a clasp is disposed at the soft head, and the block button is mated with the clasp.

The soft core includes a luminophor and a lamp holder, and the luminophor and the lamp holder is formed integrally by injection molding.

A voltage regulation diode, a resistance or other electric components can be defined in the lead of the luminophor.

The present invention has the following advantages:

1) The junction of the flowered shell and the soft core is formed integrally, which can prevent the leakage of water.

2) The present invention realizes the extension of the service life and the reduction of the use cost.

3) The present invention realizes the convenience of the replacement.

4) The present invention has the reasonable idea and the novel design, and so has the market potential.

### BRIEF DESCRIPTION OF THE DRAWINGS

FIG. 1. is a schematic view of a decorative lamp in accordance with an embodiment of the present invention;

FIG. 2 is a cross sectional view of FIG. 1;

FIG. 3 is a schematic view of a decorative lamp in accordance with another embodiment of the present invention;

FIG. 4 is a cross sectional view of FIG. 3; and

FIG. 5 is a cross sectional view in accordance with a further embodiment of the present invention.

### DESCRIPTION OF THE PREFERRED EMBODIMENT

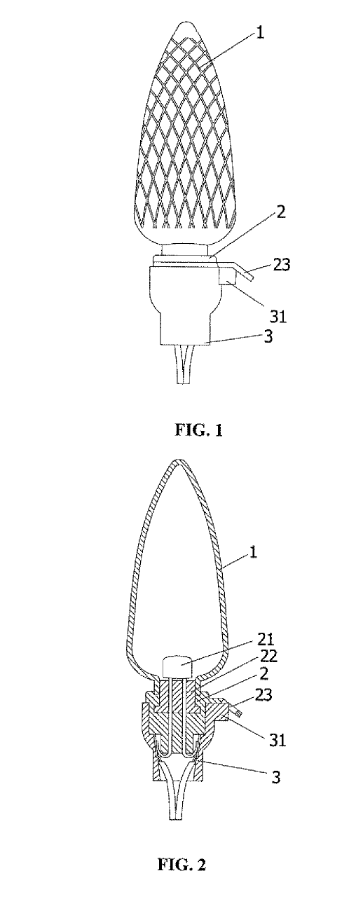

Referring to FIGS. 1-2, a decorative lamp in accordance with an embodiment of the present invention includes a flowered shell 1, a soft core 2, a soft head 3, a luminophor 21, a plug 22, a block button 23, a clasp 31. The flowered shell 1 is defined in the top of the soft core 2. The soft head 3 is defined in the bottom of the soft core 2. The fitting place of the opening of the flowered shell 1 and the soft core 2 is integrally formed by injection molding.

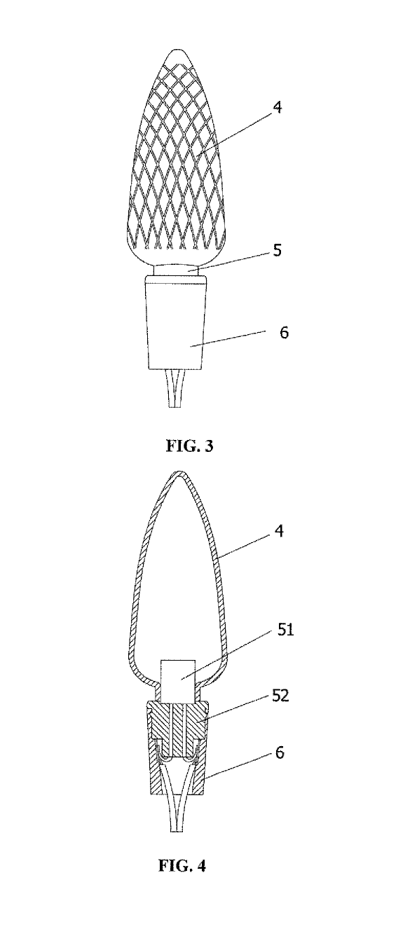

Referring to FIGS. 3-4, a decorative lamp in accordance with another embodiment of the present invention includes a flowered shell 4, a soft core 5, a luminophor 51, and a soft head 6. The flowered shell 4 is defined in the top of the soft core 5. The soft head 6 is defined in the bottom of the soft core 5. The soft core 5 includes the luminophor 51 and the lamp holder 52. The luminophor 51 and the lamp holder 52 is integrally formed by injection molding.

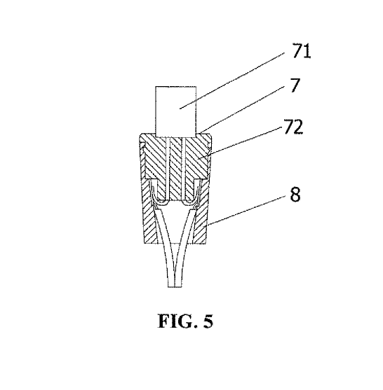

Referring to FIG. 5, a decorative lamp in accordance with a further embodiment of the present invention includes a soft core 7, a luminophor 71, a lamp holder 72 and a soft head 8. The soft head 8 is defined in the bottom of the soft core 7. The soft core 7 includes the luminophor 71 and the lamp holder 72. The luminophor 71 and the lamp holder 72 is integrally formed by injection molding.

The flowered shell is integrally formed with the soft core by fusion.

The flowered shell is integrally formed with the soft core by ultrasonic technique.

The luminophor 21 defined in the soft core 2 is an LED lamp.

The block button 23 is defined in the soft core 5, the clasp 31 is defined in the soft head, and the block button 23 is mated with the clasp 31.

What is claimed is:

1. A decorative lamp including a flowered shell, a soft core, and a soft head, the flowered shell being defined in the top of the soft core, the soft head being defined in the bottom of the soft core, wherein the fitting place of the opening of the flowered shell and the soft core is integrally formed by injection molding.

2. The decorative lamp of claim 1, wherein the flowered shell is integrally formed with the soft core by fusion.

3. The decorative lamp of claim 1, wherein the flowered shell is integrally formed with the soft core by ultrasonic technique.

4. The decorative lamp of claim 1, wherein the luminophor defined in the soft core is an LED lamp.

5. The decorative lamp of claim 1, wherein the block button is defined in the soft core, the clasp is defined in the soft head, and the block button is mated with the clasp.

6. The decorative lamp of claim 1, wherein the soft core includes the luminophor and the lamp holder, and the luminophor and the lamp holder is integrally formed by injection molding.
